(19) United States
(12) Patent Application Publication
(10) Pub. No.: US 2026/0153326 A1
(43) Pub. Date: Jun. 4, 2026

(54) Imaging device with three-dimensional information measurement function, measuring method for three-dimensional information and imaging method for image with three-dimensional information

(71) Applicant: Japan Display Inc., Tokyo (JP)

(72) Inventors: Yoshiro AOKI, Tokyo (JP); Hirondo NAKATOGAWA, Tokyo (JP); Hitoshi TANAKA, Tokyo (JP)

(21) Appl. No.: 19/396,590

(22) Filed: Nov. 21, 2025

(30) Foreign Application Priority Data
Nov. 29, 2024 (JP) 2024-209021

(51) Int. Cl. G01B 11/22; G02B 5/00; G06T 7/521; H04N 23/11

(52) U.S. Cl. CPC G01B 11/22; G02B 5/005; G06T 7/521; H04N 23/11; G02B 2207/129; G06T 2207/10028; G06T 2207/10048

(57) ABSTRACT

A depth is estimated regardless of an imaging target and an imaging condition. An imaging device with a three-dimensional information measurement function includes: a pattern projection unit including a light source and a pattern forming unit that forms a projection pattern of a light beam; an imaging unit including a lens group including at least one lens, a coded aperture that limits external light passing through the lens group in a predetermined coded pattern, a shutter, and an image sensor; and a depth calculation unit configured to obtain, based on a pattern image imaged by the imaging unit and a known point spread function related to the coded pattern, a depth distribution of an image imaged by the imaging unit.

### CROSS-REFERENCE TO RELATED APPLICATION

The present application claims priority from Japanese application JP 2024-209021 filed on Nov. 29, 2024, the content of which is hereby incorporated by reference into this application.

### BACKGROUND OF THE INVENTION

### 1. Field of the Invention

The present invention relates to an imaging device with a three-dimensional information measurement function, a measuring method for three-dimensional information, and an imaging method for an image with three-dimensional information.

### 2. Description of Related Art

A description of a coded imaging method is described in “Hajime Nagahara: Coded Imaging, Research Report of Information Processing Society, Vol. 2010-CVIM-171, No. 14, pp. 1 to 9, 2010”. It is described that, in the coded imaging method, a mask of a complicated pattern is used as an aperture (coded aperture), and a method called Depth from defocus (DFD) for estimating a depth of a scene based on point spreads of an image by controlling a shape of a point spread function (PSF) and a frequency characteristic thereof can be used.

### SUMMARY OF THE INVENTION

The invention disclosed in the present application has various aspects, and an outline of representative aspects thereof is as follows.

An imaging device with a three-dimensional information measurement function according to one aspect includes: a pattern projection unit including a light source and a pattern forming unit that forms a projection pattern of a light beam; an imaging unit including a lens group including at least one lens, a coded aperture that limits external light passing through the lens group in a predetermined coded pattern, a shutter, and an image sensor; and a depth calculation unit configured to obtain, based on a pattern image imaged by the imaging unit and a known point spread function related to the coded pattern, a depth distribution of an image imaged by the imaging unit.

A measuring method for three-dimensional information according to another aspect includes: projecting, onto an object, a predetermined pattern by a light beam; imaging an image of the object onto which the predetermined pattern is projected through a coded aperture having a predetermined coded pattern; and obtaining a depth distribution of an imaged pattern image based on the pattern image and a known point spread function related to the coded pattern.

An imaging method for an image with three-dimensional information according to still another aspect includes: projecting, onto an object, a predetermined pattern by a light beam; imaging, by an imaging unit, an image of the object, onto which the predetermined pattern is projected, through a coded aperture having a predetermined coded pattern; obtaining a depth distribution of an imaged pattern image based on the pattern image and a known point spread function related to the coded pattern; imaging, by the imaging unit, a visible light image of the object by a visible light beam; and imparting the depth distribution to the visible light image.

### BRIEF DESCRIPTION OF THE DRAWINGS

FIG. 1 is a schematic diagram of an imaging device with a three-dimensional information measurement function according to a preferred embodiment of the invention.

FIG. 2 is a schematic diagram showing a state where an object to be imaged is imaged by the imaging device with a three-dimensional information measurement function.

FIG. 3 is a diagram showing an invisible light beam image imaged by an imaging unit in an example shown in FIG. 2.

FIG. 4A is a diagram showing a principle of depth estimation using a coded aperture.

FIG. 4B is a diagram showing the principle of the depth estimation using the coded aperture.

FIG. 5A is a diagram showing an example of a projection pattern.

FIG. 5B is a diagram showing an example of the projection pattern.

FIG. 5C is a diagram showing an example of the projection pattern.

FIG. 6 is a flowchart showing a procedure of a measuring method for three-dimensional information and an imaging method for an image with three-dimensional information using the imaging device with a three-dimensional information measurement function according to the embodiment.

### DETAILED DESCRIPTION OF THE INVENTION

According to the finding of the applicant, the DFD estimates a depth of an imaged scene based on point spreads of the imaged image, but the estimation is impossible unless the imaged image is subject to be the one which is possible for point spread restoration. Therefore, in a case where there is no change over the entire image or a considerable range of the image, for example, in a case where a flat wall surface is an imaging target or the image is dark and a subject is hardly reflected in the image, the depth of the scene cannot be estimated.

The applicant has completed the invention in view of such circumstances. The invention can estimate the depth regardless of an imaging target and an imaging condition.

In the present application, in order to make a description clearer, a width, a thickness, a shape, and the like of each part may be schematically represented in the drawings as compared with actual embodiments, but they are merely examples and do not limit the interpretation of the invention. In the specification and drawings, components having the same functions as those described in connection with preceding drawings may be denoted by the same reference numerals, and a repetitive description thereof may be omitted unless necessary.

Further, in the detailed description of the invention, when a positional relationship between a certain component and another component is defined, if not otherwise stated, the words “on” and “below” suggest not only a case where the another component is disposed immediately on or below the component, but also a case where the component is disposed on or below the another component with a third component interposed therebetween.

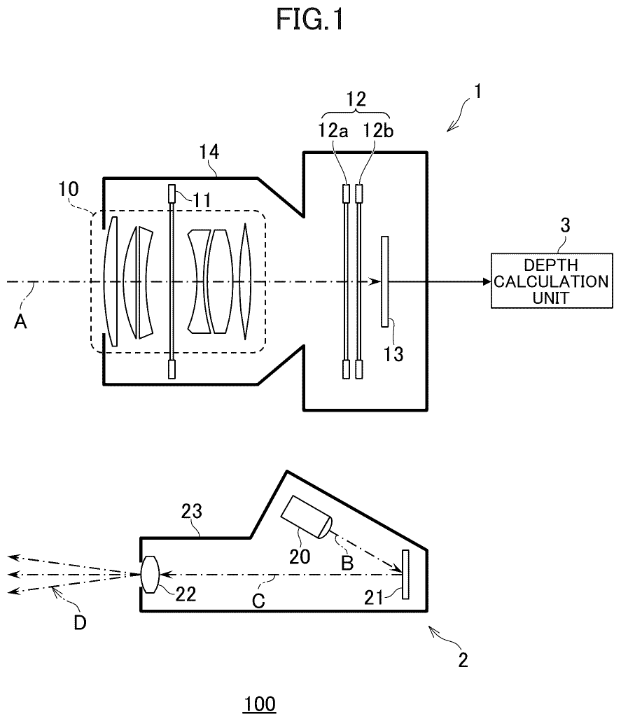

FIG. 1 is a schematic diagram of an imaging device 100 with a three-dimensional information measurement function according to a preferred embodiment of the invention. The imaging device 100 with a three-dimensional information measurement function includes an imaging unit 1, a pattern projection unit 2, and a depth calculation unit 3.

In the embodiment, the imaging unit 1 has a configuration as a so-called digital camera, and has a configuration in which a lens group 10 including at least one lens, a coded aperture 11 that limits external light passing through the lens group by a predetermined coded pattern, a shutter 12, and an image sensor 13 are accommodated in a housing 14.

The pattern projection unit 2 has a configuration in which a light source 20 that emits an invisible light beam, a pattern forming unit 21 that forms a projection pattern of the invisible light beam, and a projection lens 22 are also accommodated in a housing 23.

The depth calculation unit 3 is an information process device, and obtains a depth distribution of an imaged image by processing image data obtained by the image sensor 13 of the imaging unit 1.

The depth calculation unit 3 may be implemented separately from the imaging unit 1 so as to be able to communicate information with each other in a wired or wireless manner, or may be provided integrally with the imaging unit 1. The imaging unit 1 and the pattern projection unit 2 may not be provided in the housing 14 and the housing 23 separately as shown in FIG. 1, and may be integrally provided. A power supply circuit that supplies power to the imaging unit 1, the pattern projection unit 2, and the depth calculation unit 3, a controller that controls the imaging unit 1, the pattern projection unit 2, and the depth calculation unit 3, a user interface such as a button for operating the imaging device 100 with a three-dimensional information measurement function, an I/O for inputting and outputting information to and from an external device, an electronic circuit such as a memory and a processor, and other detailed configurations are not necessarily required for describing the imaging device 100 with a three-dimensional information measurement function, and thus illustration and detailed description thereof will be omitted.

The lens group 10 may be a set of imaging lenses used in a general camera, and may be capable of appropriately adjusting a focal length, a depth of field, and a zoom magnification. A material of each lens, a coating, a group number, and the number of lenses constituting the lens group 10 are not particularly limited, and the lens group 10 may be a fixed focus single lens. The adjustment of the lens group 10 may be performed automatically or manually.

The coded aperture 11 partially shields, by a specific mask pattern, external light transmitted through the lens group 10. As a specific example of the coded aperture 11, a black plate having an opening of a specific pattern shape or a transparent plate such as glass having a surface on which a black specific pattern is printed can be used. Further, the coded aperture 11 can be a liquid crystal shutter, and the aperture pattern can be changed. For example, the presence or absence of the coded aperture can be switched by switching between display and non-display of the specific mask pattern. Alternatively, a plurality of types of mask patterns may be switched to change the type of the coded aperture. Further, a dot matrix type liquid crystal display may be used as the liquid crystal shutter used for the coded aperture 11, any mask pattern may be displayed or not displayed, and a normal aperture pattern having a circular opening may also be displayed.

The shutter 12 is a component that functions as a shutter of a normal camera, and adjusts an exposure amount of external light to the image sensor 13. A general mechanical shutter may be used as the shutter 12, but a liquid crystal shutter is used in the embodiment. The shutter 12 includes an invisible light beam shutter 12a capable of switching between transmission and non-transmission of the invisible light beam and a visible light beam shutter 12b capable of switching between transmission and non-transmission of the visible light beam. Since the invisible light beam used in the embodiment is infrared light, the invisible light beam shutter 12a is an infrared light shutter, but when ultraviolet light is used as the invisible light beam, the invisible light beam shutter 12a may be an ultraviolet light shutter.

In a state where both the invisible light beam shutter 12a and the visible light beam shutter 12b among the shutters constituting the shutter 12 are closed, external light indicated by an alternate long and short dash line A in FIG. 1 is blocked without reaching the image sensor 13, whereas in a state where the invisible light beam shutter 12a is opened, infrared light among external light A reaches the image sensor 13. Conversely, in a state where the visible light beam shutter 12b is opened, visible light among the external light A reaches the image sensor 13, and thus the shutter 12 is a member through which the invisible light beam (infrared light in the embodiment) and the visible light beam selectively pass.

The image sensor 13 is a two-dimensional optical sensor capable of detecting the invisible light beam and the visible light beam. The type of the image sensor 13 is not limited, and may be a general complementary metal oxide semiconductor (CMOS) sensor or a charge coupled device (CCD). Detection elements arranged on the image sensor 13 may be ones in which both a detection element adapted to detection of the invisible light beam and a detection element adapted to detection of the visible light beam are arranged, or may detect both of the invisible light beam and the visible light beam at the same time without particular distinction. The image detected by the image sensor 13 may be a color image or a monochrome image.

The light source 20 is a light source that emits the invisible light beam, that is, a light beam outside a visible region, and is an infrared light source in the embodiment. In the embodiment, since the light source 20 is also a laser light source, it is an infrared laser oscillator. The invisible light beam emitted from the light source 20 is shaped using an appropriate optical system as necessary, and is incident on the pattern forming unit 21 as indicated by an alternate long and short dash line B. The light source 20 may be an ultraviolet light source.

The pattern forming unit 21 is a member that forms a projection pattern, which is a predetermined pattern when the invisible light beam emitted from the light source 20 is projected to the outside, and is a pattern mirror in the embodiment. That is, a specific pattern is engraved on the surface of the mirror, and the reflected light forms a projection pattern. In addition, the pattern forming unit 21 may be, for example, a digital micromirror device (DMD), and any projection pattern may be obtained by controlling the DMD. Further, the pattern forming unit 21 may be a scanning optical system using a polygon mirror, and may project any projection pattern by a scanning method by controlling an oscillation pattern of the invisible light beam from the light source 20 or a switching timing of shielding.

The projection lens 22 is an optical system that projects the patterned light, which is reflected and formed by the pattern forming unit 21 and indicated by an alternate long and short dash line C, to the outside. Although FIG. 1 shows a configuration using a single lens, a configuration using a plurality of lenses, or a configuration capable of adjusting a focal length, a projection magnification, and the like may be used. The projected light beam is appropriately enlarged as indicated by an alternate long and short dash line D.

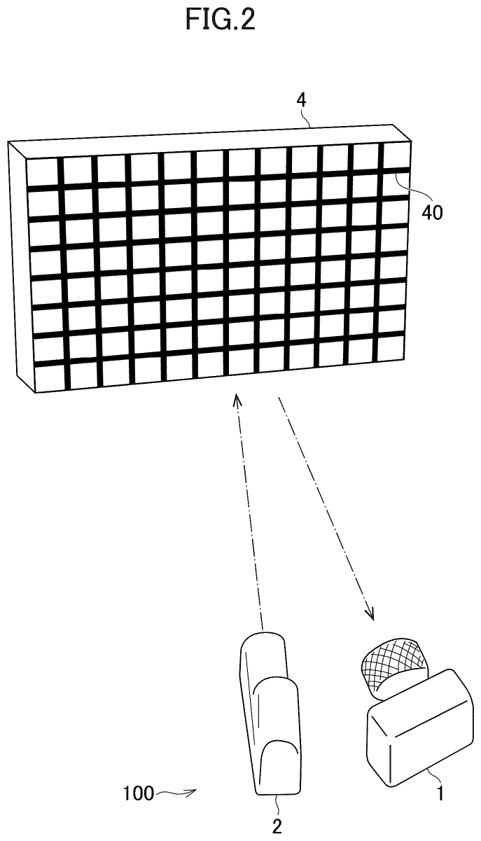

FIG. 2 is a schematic diagram showing a state where an object 4 to be imaged is imaged by the imaging device 100 with a three-dimensional information measurement function. Although depending on the type of the object 4, as shown in FIG. 2, when the surface is flat and the texture such as color change is poor, there is almost no change, between pixels constituting an image imaged by the imaging unit 1, in the image, and the point spreads cannot be detected.

Therefore, as shown in FIG. 2, the pattern projection unit 2 projects a projection pattern 40 of the invisible light beam (infrared light in the embodiment) onto the surface of the object 4. In the shown example, the projection pattern 40 is a lattice pattern. Accordingly, when an invisible light beam image is imaged by the imaging unit 1 in a state where the projection pattern 40 of the invisible light beam is projected on the surface of the object 4, the point spreads on the surface of the object 4 can be observed by the projection pattern 40, and therefore, depth estimation using the coded aperture can be performed.

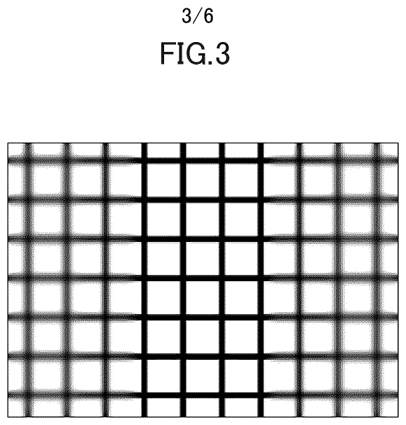

FIG. 3 is a diagram showing the invisible light beam image imaged by the imaging unit 1 in the example shown in FIG. 2. Since focus is achieved in the vicinity of the focal length determined by the lens group 10 of the imaging unit 1, the projection pattern 40 is clearly photographed in the vicinity of the center of the invisible light beam image, but the projection pattern 40 is blearily photographed toward both left and right ends of the invisible light beam image as the surface of the object 4 is separated from the focal length.

Since the depth calculation unit 3 performs the depth estimation based on the point spreads of the invisible light beam image, it is desirable that the projection pattern 40 is clearly projected on the surface of the object 4 regardless of a distance between the object 4 and the imaging device 100 with a three-dimensional information measurement function. Therefore, it is desirable that the projection pattern 40 projected from the pattern projection unit 2 does not form an image on the surface of the object 4, but is projected by simply enlarging and projecting collimated light. That is, the patterned light indicated by the alternate long and short dash line C in the pattern projection unit 2 of FIG. 1 is collimated light. Therefore, the light source 20 is desirably an appropriate collimated light source, and is a laser light source in the embodiment. Of course, when the light source 20 does not use the laser light source, any light source and an appropriate collimator may be provided.

As is clear from FIG. 3, since the depth calculation unit 3 performs the depth estimation based on the point spreads of the invisible light beam image, the depth is estimated based on the focal length of the optical system of the imaging unit 1. Therefore, the focal length of the lens group 10 when the imaging unit 1 images the invisible light beam image is known. When the lens group 10 is a fixed focus lens, the focal length of the lens is used. When the lens group 10 is a varifocal lens, the focal length at the time of imaging is used, or the arrangement of lenses provided in the lens group 10 whose focal length is known in advance is used at the time of imaging.

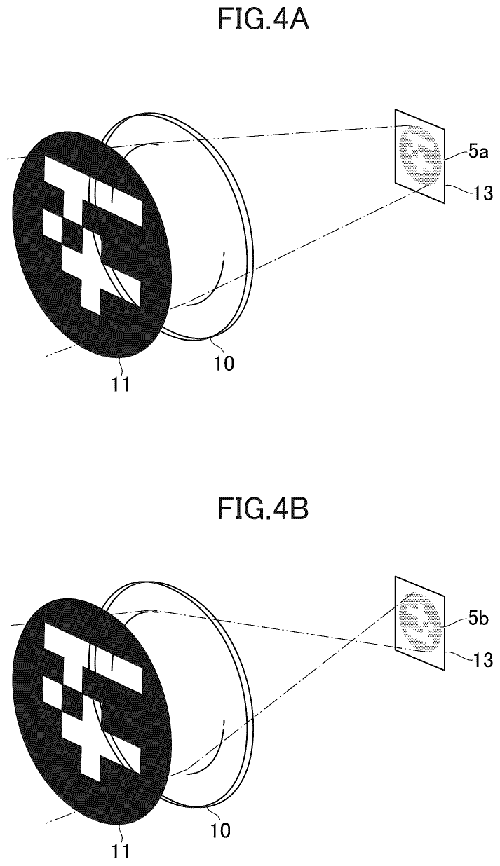

FIGS. 4A and 4B are diagrams showing a principle of the depth estimation using the coded aperture 11. FIGS. 4A and 4B schematically show a state where external light that has passed through the coded aperture 11 is refracted by the lens group 10 (here, shown as a single lens for simplicity of illustration) and strikes the image sensor 13. FIG. 4A shows an optical path of a light beam from the surface of the object 4 at a distance shorter than the focal length of the lens group 10, and FIG. 4B shows an optical path of a light beam from the surface of the object 4 at a distance longer than the focal length of the lens group 10, with alternate long and short dash lines.

In both of the examples of FIGS. 4A and 4B, the light beam from the surface of the object 4 is not form an image on the image sensor 13, and is imaged in a point spreaded manner. At this time, in the case shown in FIG. 4A, the light beam coded by passing through the coded aperture 11 enters the image sensor 13 in a coding direction indicated by 5a without changing a geometric positional relationship of the coding.

For the sake of convenience, in the coding direction 5a of FIG. 4A, the coded pattern of the coded aperture 11 is shown as being projected on the surface of the image sensor 13, but this is not the case in practice, and FIG. 4A shows that a spatial frequency characteristic of the point spread of the light beam entering the image sensor 13 follows the PSF corresponding to the coded pattern indicated by the coding direction 5a. Hereinafter, this geometric positional relationship is referred to as a forward direction, and the PSF at this time is referred to as a forward direction PSF.

On the other hand, in the case shown in FIG. 4B, the light beam coded by passing through the coded aperture 11 enters the image sensor 13 in a coding direction indicated by 5b in a state where the geometric positional relationship of the coding is vertically and horizontally inverted. Similarly to the coding direction 5a in FIG. 4A, the coding direction 5b in FIG. 4B indicates that the spatial frequency characteristic of the point spread of the light beam entering the image sensor 13 follows the PSF corresponding to the coded pattern indicated by the coding direction 5b. Hereinafter, this geometric positional relationship is referred to as a reverse direction, and the PSF at this time is referred to as a reverse direction PSF.

At this time, when the forward direction PSF and the reverse direction PSF are the same, it is not possible to determine whether a position of the surface of the object 4 is farther or closer than the focal length of the lens group 10 based on the point spreads of the image imaged by the image sensor 13. On the other hand, since the coding direction 5a and the coding direction 5b have a positional relationship of being rotated by 180 degrees with respect to an optical axis, when the coded pattern in the coded aperture 11 is a figure capable of distinguishing both the coding direction 5a and the coding direction 5b, that is, a two-fold asymmetric figure as shown in FIGS. 4A and 4B, the forward direction PSF and the reverse direction PSF are different from each other, and the distance with respect to the focal length of the lens group 10 on the surface of the object 4 can also be determined using each PSF.

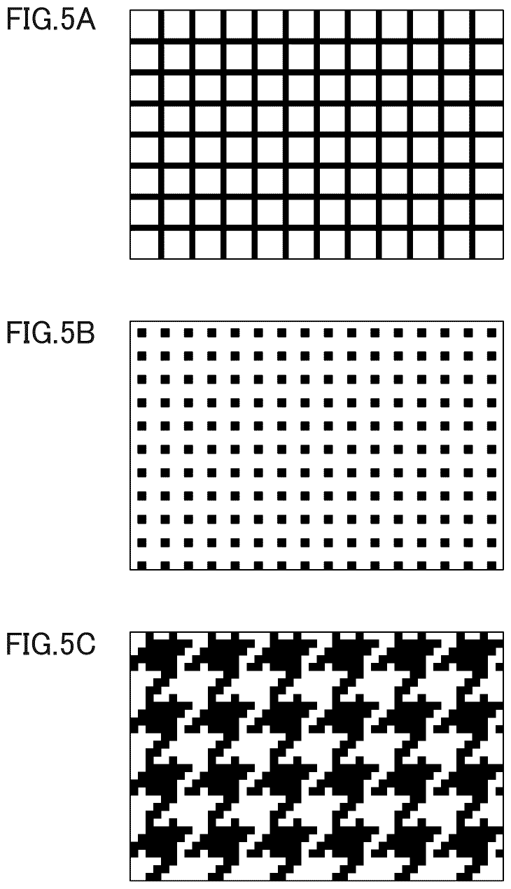

In the example described above, the projection pattern 40 projected by the pattern projection unit 2 is a lattice pattern, but a specific shape of the projection pattern 40 may be arbitrary. FIGS. 5A to 5C show examples of the projection pattern 40. FIG. 5A shows a lattice pattern described above, FIG. 5B shows a dot matrix pattern, and FIG. 5C shows a houndstooth pattern. The projection pattern 40 may be selected according to a surface material of the object 4, an assumed distance to the object 4, and the like, or may be switched and projected in the pattern projection unit 2.

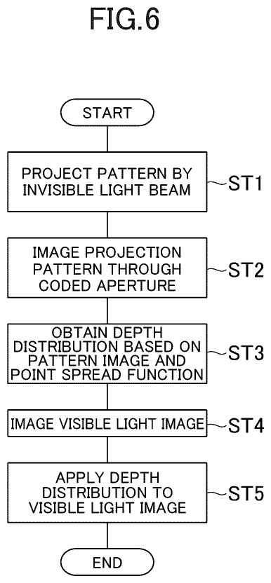

FIG. 6 is a flowchart showing a procedure of a measuring method for three-dimensional information and an imaging method for an image with three-dimensional information using the imaging device with a three-dimensional information measurement function 100 according to the embodiment.

First, in step ST1, the pattern projection unit 2 projects a predetermined pattern of invisible light beam onto the object 4. Accordingly, as exemplarily shown in FIG. 2, the projection pattern 40 of the invisible light beam is projected on the surface of the object 4.

In the subsequent step ST2, the object 4 on which the projection pattern 40 is projected is imaged by the imaging unit 1 through the coded aperture 11. At this time, the imaging unit 1 shown in FIG. 1 is controlled such that a predetermined specific mask pattern is displayed when the coded aperture 11 can change the aperture pattern. The lens group 10 is maintained at a setting suitable for imaging the object 4, and the focal length thereof is known. The shutter 12 opens the invisible light beam shutter 12a for a predetermined time to expose the image sensor 13 to external light, and the visible light beam shutter 12b is closed to operate such that the image sensor 13 can image only invisible light. As a result, a pattern image is obtained by the image sensor 13.

Further, in step ST3, the depth calculation unit 3 performs deconvolution using a known PSF (a point spread function) on the pattern image obtained by the image sensor 13, and estimates a depth of each portion of the pattern image. The depth of each portion of the pattern image obtained in this way is an image indicating a depth distribution in a plane of the pattern image, and this can be referred to as a depth distribution.

By the above steps ST1 to ST3, the depth distribution with respect to the object 4, that is, three-dimensional information of the object 4 is measured, and such information may be used for, for example, various types of measurement and modeling of the object 4. Therefore, steps ST1 to ST3 constitute the measuring method for three-dimensional information.

Further, in step ST4, the imaging unit 1 images a visible light image of the object 4 by visible light beam. At this time, when the coded aperture 11 can change the aperture pattern, the imaging unit 1 shown in FIG. 1 may not display a specific mask pattern for coding or display a normal circular aperture pattern. When the coded aperture 11 displays a fixed pattern, the object 4 can be imaged with visible light beam even if the specific mask pattern remains displayed. The lens group 10 is continuously maintained at the setting suitable for imaging the object 4. The shutter 12 operates such that the invisible light beam shutter 12a is closed and the projection pattern 40 is not imaged by the image sensor 13, and the visible light beam shutter 12b is opened for a predetermined time so that the visible light image of the object 4 is exposed to the image sensor 13. As a result, a natural image of the object 4 by visible light is imaged by the image sensor 13.

Step ST4 is not necessarily performed after steps ST2 and ST3, and may be performed before or after step ST2. When the imaging unit 1 is not fixed, it is desirable that step ST2 and step ST4 are performed continuously, that is, substantially simultaneously, and the pattern image and the visible light image are imaged substantially simultaneously. This is because the pattern image and the visible light image are obtained by imaging the object 4 from the same angle, and a positional relationship in images of the object 4 photographed in the pattern image and the visible light image is the same, and the pattern image and the visible light image can be superimposed on each other.

Finally, in step ST5, the depth distribution obtained in step ST3 is applied to the visible light image obtained in step ST4. Specifically, it can be implemented by, in a visible light image including RGB information (or information according to an appropriate color system such as CMY) for each pixel, further adding Z information which is information indicating a depth for each pixel, or further adding an image indicating a depth distribution to the visible light image including a set of color images such as RGB.

As a result, in steps ST1 to ST5, an image, to which the depth distribution with respect to the object 4, that is, the three-dimensional information of the object 4 is applied, is imaged. Since such an image is obtained by further adding information in the depth direction to an image that is originally a plane, the image can be used for various applications such as measurement, modeling, and object recognition, and can be used for various uses. Therefore, steps ST1 to ST5 constitute the imaging method for an image with three-dimensional information.

In the embodiment described above, the light source 20 emits invisible light beam, and the light emitted from the pattern projection unit 2 is invisible light, so that the pattern projected on the object 4 can be made invisible when the three-dimensional information of the object 4 is measured. However, the invention is not limited to this, and when a pattern of visible light may be projected onto the object 4, the light source 20 may emit visible light, and the pattern of visible light may be projected from the pattern projection unit 2. In this case, since the visible light is used for the projection pattern, the invisible light beam shutter 12a is unnecessary, and the weight of the imaging unit 1 can be reduced.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An imaging device with a three-dimensional information measurement function, comprising:
a pattern projection unit including a light source that emits a light beam and a pattern forming unit that forms a projection pattern of the light beam;
an imaging unit including a lens group including at least one lens, a coded aperture that limits external light passing through the lens group in a predetermined coded pattern, a shutter, and an image sensor; and
a depth calculation unit configured to obtain, based on a pattern image imaged by the imaging unit and a known point spread function related to the coded pattern, a depth distribution of an image imaged by the imaging unit.

2. The imaging device with a three-dimensional information measurement function according to claim 1, wherein
the light source is a laser light source.

3. The imaging device with a three-dimensional information measurement function according to claim 1, wherein
an aperture pattern of the coded aperture is a two-fold asymmetric figure.

4. The imaging device with a three-dimensional information measurement function according to claim 1, wherein
the coded aperture is a liquid crystal shutter, and is capable of changing an aperture pattern.

5. The imaging device with a three-dimensional information measurement function according to claim 1, wherein
the light beam emitted by the light source is an invisible light beam, and
the image sensor is capable of detecting the invisible light beam and a visible light beam.

6. The imaging device with a three-dimensional information measurement function according to claim 5, wherein
the shutter includes an invisible light beam shutter capable of switching between transmission and non-transmission of the invisible light beam and a visible light beam shutter capable of switching between transmission and non-transmission of the visible light beam.

7. The imaging device with a three-dimensional information measurement function according to claim 6, wherein
the invisible light beam is infrared light.

8. A measuring method for three-dimensional information comprising:
projecting, onto an object, a predetermined pattern by a light beam;
imaging an image of the object onto which the predetermined pattern is projected through a coded aperture having a predetermined coded pattern; and
obtaining a depth distribution of an imaged pattern image based on the pattern image and a known point spread function related to the coded pattern.

9. The measuring method for three-dimensional information according to claim 8, wherein
the light beam is an invisible light beam.

10. An imaging method for an image with three-dimensional information comprising:
projecting, onto an object, a predetermined pattern by a light beam;
imaging, by an imaging unit, an image of the object, onto which the predetermined pattern is projected, through a coded aperture having a predetermined coded pattern;
obtaining a depth distribution of an imaged pattern image based on the pattern image and a known point spread function related to the coded pattern;
imaging, by the imaging unit, a visible light image of the object by a visible light beam; and
imparting the depth distribution to the visible light image.

11. The imaging method for an image with three-dimensional information according to claim 10, wherein
the light beam is an invisible light beam.
